(19) United States
(12) Patent Application Publication
(10) Pub. No.: US 2002/0099582 A1
(43) Pub. Date: Jul. 25, 2002

(54) Apparatus and method of providing business solutions and services

(76) Inventors: Steve Buckley, White Plains, NY (US); Heng Cao, White Plains, NY (US); Guillermo Gallego, Ridgewood, NJ (US); Shubir Kapoor, Mohegan Lake, NY (US); Kaan Katircioglu, Peekskill, NY (US); Oyedele Oladeji, Superior, CO (US)

Correspondence Address: McGuire Woods, LLP, Tysons Corner, 1750 Tysons Boulevard, Suite 1800, McLean, VA, 22102-3915, US

(21) Appl. No.: 09/767,730

(22) Filed: Jan. 24, 2001

(51) Int. Cl. G06F 17/60

(52) U.S. Cl. 705/7

(57) ABSTRACT

A method and system of providing business solutions via a dynamic system. In order to provide business solutions, the method and system uses rules to formulate questions based on (i) specific industries, (ii) specific problems and/or (ii) specific answers in response to a dynamic set of questions (metrics), amongst others. These specific solutions may also be quantified in order to provide specific financial benefit analysis to the business using spreadsheets and financial software based on quantitative data provided by the user.

### BACKGROUND OF THE INVENTION

1. Field of the Invention

The present invention generally relates to an apparatus and method of providing business solutions and, more particularly, to a method and system of selling and justifying business solutions and services via a dynamic system.

2. Background Description

Business solutions are of increasing importance in a highly competitive marketplace. These business solutions can provide competitive advantages to a business thus increasing efficiency. This efficiency may then, in turn, lead to increased profits and untold other values to the business. Some business solutions may include streamlining inventory as well as more efficiently deploying a sales force within a specific demographic or geographic region. In either one of these solutions, as well as an untold number of other solutions, a business may be able to more efficiently sell its products, maintain an optimal level of inventory without disrupting a business supply chain or provide better services to its clients and customers, amongst other advantages.

Current business solutions are devised using consultants, accountants and sales people. By using these highly skilled and talented people there is a need that each individual be intimately familiar with the particular business. This will then allow each individual to identify the business problem and hence contribute to the needed business solution. This process, however, is very time and labor intensive thus leading to increased costs.

It is further noted that businesses are dynamic thus changing with the times and marketplace environment. This dynamic nature of a business translates into the need for different solutions on a fairly frequent basis. This, again, requires a team of individuals to constantly evaluate and reevaluate the business and marketplace environment to provide appropriate solutions. This can be an expensive process. Needless to say, this process also takes away valuable resources from the business such as preventing a sales person from generating sales and profits for the business.

Another problem associated with finding proper business solutions is that there are so many different and overlapping solutions and services. Needless to say, finding the most appropriate solutions which can most improve the business is very complex. First, the business must be assessed to determine the weakest point or most susceptibility to competitive forces. Second, the potential solutions must be identified to address the weak points. Third, the potential solutions must be assessed to see which solutions and accompanying services would generate the most financial improvement in the business. As discussed above, this process is normally performed manually by a sales and consulting team, but may also be aided by simple spreadsheet or financial software. This process is time consuming, labor intensive and, in many instances, cost prohibitive. Due to these constraints and the many overlapping solutions, some businesses opt not to seek any solutions while others may seek the wrong solutions.

The world wide web portion of the Internet has been recently employed to provide processes to help assist a business in seeking a solution to a problem. These world wide web based processes are based on two simple methods: (i) displaying the business's products on screens and (ii) allowing the user to search for products based on specified keywords. These simple methods perform well only if the user knows what they are looking for in order to solve the business problem. However, in many instances a user does not know the specific problem and will thus not be able to solve such problem by providing an appropriate solution. That is, when a business has a business problem, they may not know which solutions solve which problems, which problems are most critical and which solutions are the most effective. In such cases, existing web based methods are not very effective. Instead, the solution must again be provided by consultants or knowledgeable sales people.

In other web based applications, a questionnaire is used to assist the user in solving the business problem and thus providing a solution. But, generally these questionnaires are static in nature and require the user to answer all of the questions prior to providing a solution. If the number of questions is large, which is usually the case, users are reluctant to answer all of the questions. Also, in many of these static processes, it is difficult to even determine a solution by the questions that are asked during the process.

### SUMMARY OF THE INVENTION

The present invention is an improvement over prior art systems from three standpoints. One, more business clients have access to the world wide web portion of the Internet or other communications medium than to a host of expensive consultants. Two, the cost of selling a solution or service will decrease because some of the process will be performed without the aid of expensive consultants. Three, there is reduced content maintenance; that is, should the content change (i.e., a new question is added) only the database and the expert rules have to modified. Thus, no new programming is needed nor do any of the web pages have to be modified.

In one aspect of the present invention, a method of providing business solutions over an interactive communications medium is provided. The method includes selectively providing metrics which are associated with a business problem and a specific industry and providing a business solution based on the selective metrics and responses to the selective metrics.

In another aspect of the present invention a method is provided for providing business solutions over an interactive communications medium. The method includes identifying a specific industry and providing at least one business measure associated with a particular financial aspect of the specific industry. The method further includes providing a set of questions associated with problems of the specific industry, where the set of questions are related to each of the provided at least one business measure. A business solution is provided based on responses to the set of questions and the specific industry.

In yet another aspect of the present invention a system is provided for providing business solutions over an interactive communications medium. The system includes a business driver module which stores business measures associated with a specific industry and a business metrics module which stores questions associated with the specific industry and a selected business measure. The system further includes a business solution module which provides business solutions based on responses to the selected questions stored in the business metrics module and the specific industry.

In still another aspect of the present invention, a machine readable medium containing code for providing business solutions over an interactive communications medium is provided. The code implements the steps of selectively providing metrics which are associated with a business problem and a specific industry and providing a business solution based on the selective metrics and responses to the selective metrics.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the system architecture of the present invention;

FIG. 2 is a flow diagram showing the steps of implementing the method of the present invention;

FIG. 3 is an exemplary inventory driver and metrics flow diagram implementing an embodiment of the present invention; and

FIG. 4 is a high level diagram showing the implementation of the apparatus and method of the present invention.

### DETAILED DESCRIPTION OF A PREFERRED EMBODIMENT OF THE INVENTION

The present invention preferably uses the world wide web portion of the Internet to automate the entire process of providing business solutions. It should be realized by those of ordinary skill in the art, however, that the present invention is also easily adaptable for use in voice enabled web browsers as well as other voice communications (telephone), personal digital assistants (PDA) and a host of other communication systems. In order to provide business solutions, the present invention uses rules based engines to formulate questions based on (i) specific industries, (ii) specific problems and/or (ii) specific answers in response to a dynamic set of questions (metrics), amongst others. These specific solutions may also be quantified in order to provide specific a financial benefit analysis to the business using spreadsheets and financial software based on quantitative data provided by the user of the present invention.

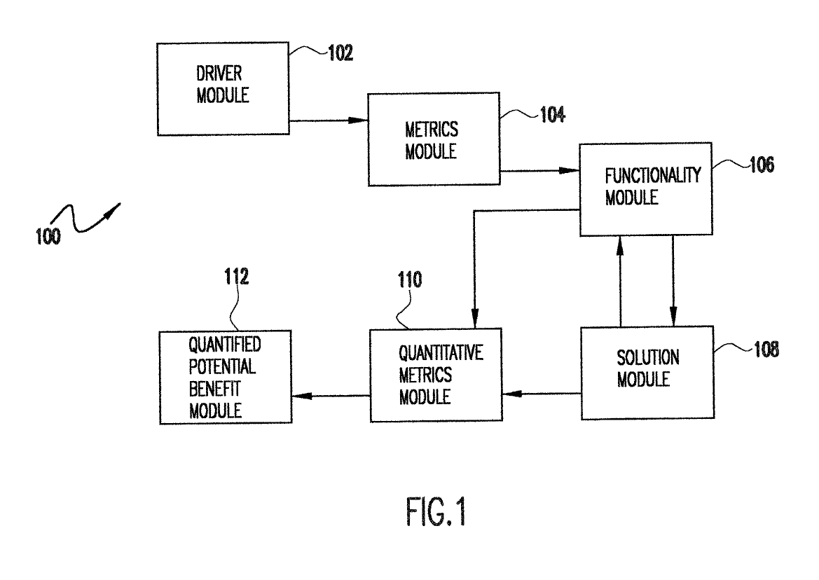

Referring now to the drawings and more particularly to FIG. 1, a high level block diagram of the system architecture of the present invention is provided. The system architecture of the present invention is generally depicted as reference numeral 100 and includes a driver module 102. The driver module 102 includes a set of specific measures associated with a particular financial aspect of the relevant business. The driver module 102 may be associated with, but is not limited to, the following business aspects:

1. Inventory;

2. Revenue;

3. Costs of goods sold;

4. Selling and administrative expenses;

5. Fixed assets;

6. Accounts receivable; and

7. Accounts payable.

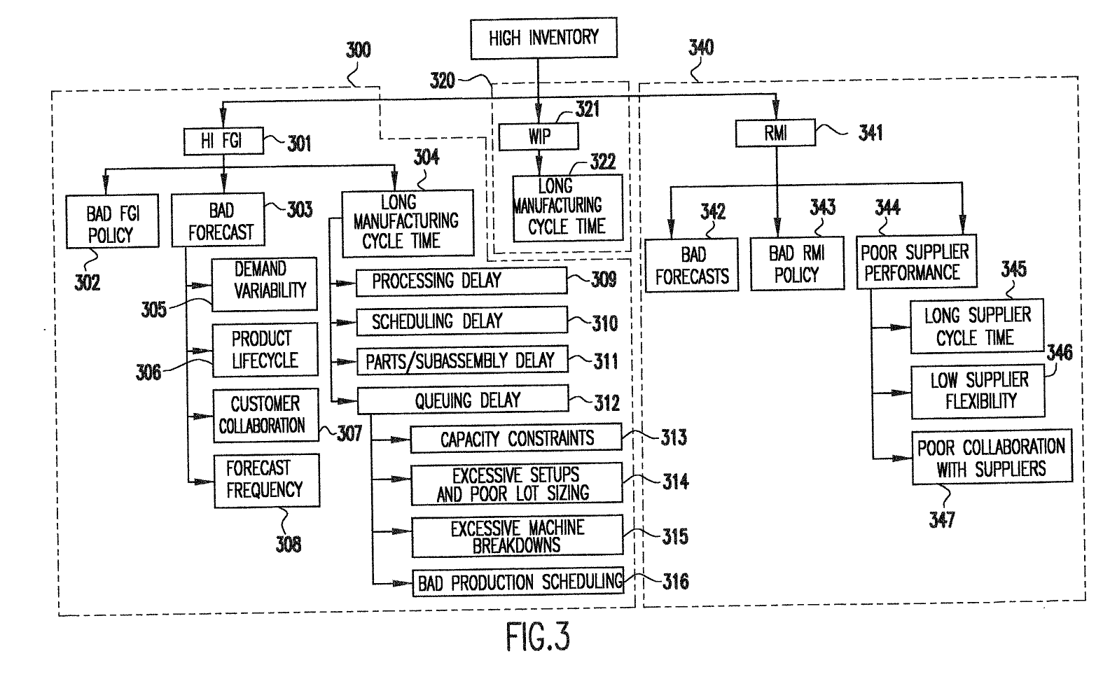

Still referring to FIG. 1, the system architecture 100 of the present invention also includes a metrics module 104 which is used to develop a set of specific questions associated with each business measure of the driver module 102. . By way of example, if the specific business measure of the driver module 102 is “Inventory”, the metrics module 104 may request from the user whether there is a high inventory due to an improper finished good policy. Of course other questions may also be used with the present invention depending on the specific business measures selected from the driver module 104, one of which is discussed with reference to FIG. 3.

It should be understood by those of skill in the art that the metrics module 104 may include a set of questions which simply require a response that is within a certain range or a “yes” or “no” response (instead of specific quantitative responses) in order to simplify the analysis used to provide the solution. In the case of a range of questions, industry benchmarks are used to determine whether a given range is acceptable or problematic. Alternatively, the metrics module may solicit more quantitative response. In either scenario, the questions are termed “metrics” which are used in conjunction with the responses thereto to determine the generic or specific solution to the business problem. The metrics are preferably provided in a hierarchical tree format as shown in FIG. 3.

The user response (to the question presented by the metrics module 104) is then used to either generate new pertinent questions or to map generic solutions provided by a functionality module 106. A functionality is a generalization as to what a solution may accomplish. Also, one solution may perform several functionalities, for example, a CRM solution may manage a company's call center and monitor the same company's web site. The system of the present invention can be used to rule out some of the proposed solutions based on information about the business such as geography and revenue. The remaining solutions may then be used to determine a specific solution or passed to a financial program which estimates the financial benefit of each solution. The mapping of the solution is preferably performed by a rules based engine such as the Blaze Advisor™ (a product of Blaze Software Inc.) which is implemented in the Websphere Commerce Suite™ manufactured by International Business Machines, Corp. The present invention is not limited to the Blaze Advisor™, and may be used with any rules based engine which is adaptable for use with the present invention.

The system architecture 100 also includes a solutions module 108. The specific solutions derived in the solutions module 108 are obtained from the identified problem or general solution associated with the functionality module 106, which may then be implemented by the business. The identified problem and the solutions may be stored in a database. Such specific solutions obtained by the solutions module 108 may be to reduce inventory, improve customer relationships or change business processes and job responsibilities.

The functionality module 106 and/or the solutions module 108 may also be associated with a quantitative metrics module 110, which contains a mathematical model that represents the current performance of the customer's business. The quantitative metrics module 110 is used to request specific quantitative answers (actual figures) from the user based on the responses associated with the metrics module 104. These specific quantitative questions are also termed “metrics”. A specific quantitative user response may be, for example, inventory turns over the past year or on-time customer service over the past year. The specific quantitative user response can then be used by the quantified potential benefit module 112 in order to determine a financial benefit analysis of implementing a specific solution. The quantified potential benefit module 112 may be a financial or spreadsheet program which is capable of providing the required financial benefit analysis.

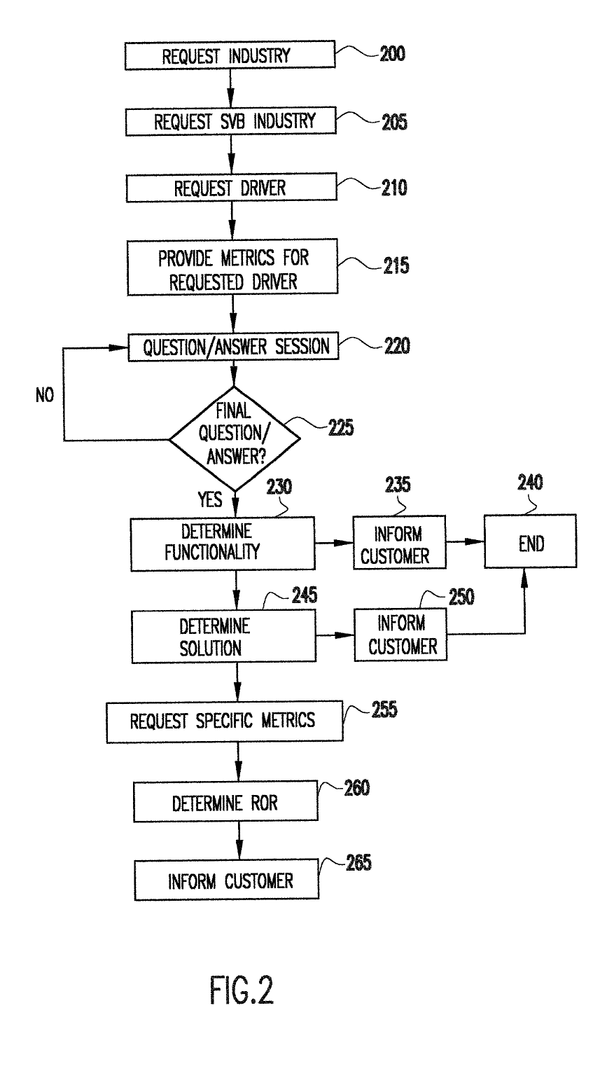

FIG. 2 is a flow diagram showing the steps of implementing the method of the present invention. In step 200, the process of the present invention requests a specific industry input from the user. This industry input, by way of example, may be industrial, wholesale or retail industries. Of course a host of other industries can be implemented and used with the system and process of the present invention. In step 205, the process of the present invention requests a specific industry code (SIC) from the user. The SIC is well known in the industry and a discussion thereof is thus omitted from the present discussion.

Once the industry and SIC are provided by the user, the process of the present invention requests the user to select a specific business measure (e.g., business driver) (step 210). The user can select one or more drivers such as, for example, inventory and revenue. The driver will be an industry specific measure related to the selected industry and SIC. Once the user selects the specific driver or drivers, the process of the present invention will then determine the related metrics module which is associated with the specific driver (step 215).

Once the appropriate metrics module is selected, in step 220, the process begins a question and answer session based on the selected metrics module. The questions are relevant to the specific business measure and are presented on via a dynamic process using a rules based engine. In this manner, the present invention will not ask the same question twice, and only pertinent questions related to (i) the driver or drivers, (ii) the selected SIC and (iii) previous responses will be presented to the user. The user thus never sees unnecessary questions. These questions and answers are used, in part, to determine the business solutions.

In step 225, a determination will be made as to whether there are any more questions needed in order to provide a solution (e.g., functionality) to the user. If further questions are needed, the process returns to step 220 to ask another question and receive a response thereto. If no further questions are needed, the process of the present invention determines the functionality or generic solution to the business problem (step 230) based, in part, on the metrics and responses thereto. In step 235, the user is provided with the generic solution. The generic solution is formulated via a rules based engine based on certain criteria such as (i) the metrics (i.e., questions and related answers) and (ii) the SIC. The process ends in step 240.

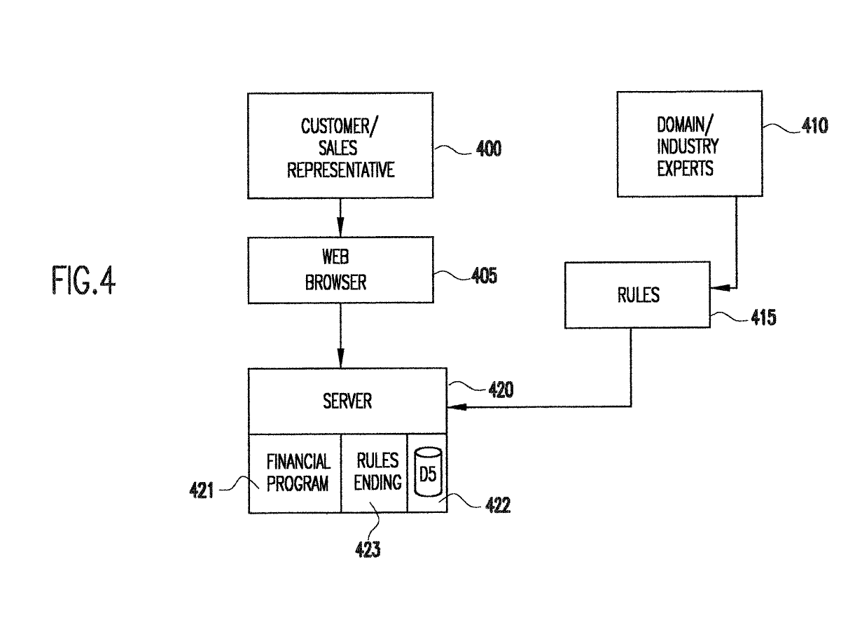

In embodiments, the process of the present invention may further determine a specific solution to the business problem (step 245). The specific solution may be based on (i) the metrics (ii) the SIC, (iii) the functionality and/or (iv) the user's demographics. A host of solutions can be stored in a database as shown in FIG. 4, and are determined based on rules provided in any known rules based engine which can be implemented by those of ordinary skill in the art. In step 250, the user is provided with the solution.

After the user is provided with the solution, the process of the present invention may then determine the financial benefits of the solution. These financial benefits may be in terms of savings, financial benefits to the business and the like. Specifically, in step 255, the process requests the input of certain specific quantitative metrics such as, for example, “the specific amount of inventory during the month of January” or “the amount of revenue gained on the sale of ‘widgets’ in the first quarter of the present year”. The answers to these specific questions (e.g., the quantitative metrics) are then used by a spreadsheet or financial program, in step 260, to determine a rate of return (ROR), a return of investment (ROI) or other financial analysis such as return on assets (ROA). The financial benefit is then shown to the user in step 265. The steps 245 to 265 or any part thereof may be transparent to the user in which case an authorized user would provide this information to the user for a fee or other consideration.

The specific solutions as well as the functionalities (generic solutions) may also be ranked based on a range of the metrics. These rankings can then be used to determine the most critical or severe problems encountered by the business, and which need to be immediately addressed in order to improve the business. This ranking can be implemented via a host of different rules which are provided to the system of the present invention and stored in a database. By way of one example, a user may provide an answer to a specific question (metrics) which is below a known standard. This system of the present invention would then “flag” the severity of a problem such that the problem and the solution would have a high priority ranking. By using this ranking system, the business can better prioritize its problems and needed solutions.

FIG. 3 shows an embodiment of the metrics used in an exemplary illustration of the present invention. In general, FIG. 3 is used to evaluate various metrics to determine the causes of the problem in each selected business driver. At each node of the decision tree of FIG. 3, the logic determines whether there is a weakness in the business and, if so, goes deeper into the tree until an appropriate solution can be provided. That is, when a weakness is detected at a node of the decision tree, a functionality is identified and, ultimately, a solution is provided to the business. It is noted that other metrics may be used with the present invention, and that the metrics of FIG. 3 are not meant to limit the measure of the present invention. The metrics of FIG. 3 are provided in a hierarchical tree format and presented to the user based on rules generated by a rules based engine.

With specificity, FIG. 3 relates to an inventory driver. The metrics of FIG. 3 include three branches, 300, 320 and 340. Each of the branches 300, 320 and 340 include specific questions (nodes) which are related to a specific branch. For example, branch 300 includes nodes 301 to 316, where nodes 302-316 all relate to the high level node 301. This same sequence and logic also applies to branches 320 and 340. The specific metrics related to the individual nodes will be presented to the user based on a previous response as defined by rules generated by the rules based engine.

As an example of use of FIG. 3, a business may have a problem with high finished goods inventory (FGI). In this case, the metrics of node 301 will be presented to the user. The next three nodes 302, 303 and 304 of the adjacent lower levels, either individually or together, will then be displayed to the user. If the business has a problem with, for example, bad FGI policy, the user will then select the node 302. Alternatively, the user may provide a range of information associated with the bad FGI policy. In either scenario, the process of the present invention will use these metrics (and responses thereto), in conjunction with the known industry, to provide a general solution. A more specific solution may then be derived from the generic solution. Both the generic and specific solution as well as the metrics and responses thereto will be stored in a database.

As another example, the business may still have a problem with high finished goods inventory (FGI), but will also have either bad forecasts (node 303) or long manufacturing cycle time (node 304). In the scenario of long manufacturing cycle time, the user will select the metrics of node 304. The user may then be prompted to select the metrics of nodes 309 to 318, depending on the specific business problem. However, depending on any previous answer only a next pertinent lower level metrics will be presented to the user. For example, if there is not a problem with queuing delay (node 312) then the system of the present invention will not show the metrics of nodes 313 to 316.

From the above discussion, it should further be recognized that the business may have several problems such as high FGI and work in process (WIP). In this scenario, the present invention will show the metrics of both nodes 301 and 321. But, the metrics of nodes 304 and 322 are duplicate metrics and will not be reused for both of the presented problems. The rules of the rules based engine will thus determine that duplicate metrics may be presented to the user and will thus eliminate the need to request this information twice during the same or subsequent sessions. Accordingly, the user will need to respond only once to this metric while the process of the present invention will use this response in both branches 300 and 320.

FIG. 4 is a high level diagram showing the implementation of the apparatus and method of the present invention. Specifically, a user or customer 400 accesses a server 420 via a web browser 410 located on the world wide web portion of the Internet. The server 420 may include a financial program 421, a database 422 and a rules based engine 423. The financial program 421, database 422 and rules based engine 423 may also be provided remotely from the server 420. Domain/industry experts 410 provide the rules 415 to the server 420 and more particularly to the rules based engine 423. The doamin/industry experts also provide data to the database 422.

In the embodiments of the present invention the financial program may be a spread sheet or other financial tool which is capable of providing a financial benefit analysis of the solution provided by the present invention. The database 422 stores the business specific drivers, the metrics (including quantitative metrics) and the general and specific solutions. The rules based engine provides the rules for selecting and/or determining the metrics (including quantitative metrics) and the solutions. By being associated with the server 420, the customer may thus access and be provided with the solutions and metrics in accordance with the present invention.

The present invention is also capable of storing a user profile irrespective of the medium used to access the system and method of the present invention. This allows the user to answer questions at different times and at different remote locations. All medium used to access the system and the method of the present invention will also allow the user to perform “what-if” analysis in order to generate different responses based on a desired business strategy. The present invention can also be used as a training tool for service consultants. By way of example, a newly hired consultant can be presented with several different scenarios in order to learn certain problems and associated solutions.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method of providing business solutions over an interactive communications medium, comprising the steps of:
selectively providing metrics which are associated with a business problem and a specific industry; and
providing a business solution based on the selective metrics and responses to the selective metrics.

2. The method of claim 1, further comprising the steps of:
selecting the specific industry; and
providing a business driver based on the selected specific industry,
wherein the selective metrics are associated with the selected specific industry and the business driver.

3. The method of claim 2, further comprising the step of selecting a specific industry code associated with the selected specific industry.

4. The method of claim 2, wherein the business solution is a general business solution based on the selected metrics and the specific industry.

5. The method of claim 4, further comprising the step of providing a specific business solution based on the general business solution, wherein the general business solution and the specific business solution are stored in a database and are provided based on a set of rules.

6. The method of claim 5, wherein the specific business solution is transparent to a user.

7. The method of claim 5, further comprising the step of ranking one of the general business solution and the specific business solution in order of business priority based on ranking rules.

8. The method of claim 7, further comprising the step of storing the selective metrics, the business driver, the specific industry code and the responses to the selective metrics in the database.

9. The method of claim 2, wherein the business driver is a business specific measure defined as one of inventory, revenue, costs of goods sold, selling and administrative expenses, fixed assets, accounts receivable, and accounts payable.

10. The method of claim 9, wherein the selected metrics are questions based on the specific industry and the business driver.

11. The method of claim 9, wherein a next question of the selective metrics is based on a previous question and a previous answer.

12. The method of claim 11, further comprising the step of providing rules for determining the next question based on the previous answer.

13. The method of claim 12, wherein the rules determine whether the next question is a duplicate of a previous question such that the previous question is selected only once.

14. The method of claim 13, wherein the rules determine that no further question is selected.

15. The method of claim 1, further comprising the step of providing quantitative metrics based on the selective metrics and the response.

16. The method of claim 15, further comprising the step of providing a financial analysis of the business solution based on at least one quantitative response to the quantitative metrics.

17. The method of claim 16, wherein the financial analysis is a rate of return (ROR), a return on investment (ROI) or a return on assets (ROA).

18. A method for providing business solutions over an interactive communications medium, comprising:
identifying a specific industry;
providing at least one business measure associated with a particular financial aspect of the specific industry;
providing a set of questions associated with problems of the specific industry, the set of questions being related to each of the provided at least one business measure; and
providing a business solution based on responses to the set of questions and the specific industry.

19. The method of claim 18, wherein:
the business solution is one of a general business solution and a specific business solution,
the general business solution is based on the responses and the specific industry, and
the specific business solution is based on the general business solution.

20. The method of claim 19, further comprising the step of ranking one of the general business solution and the specific business solution in order of business priority based on ranking rules.

21. The method of claim 18, further comprising the step of providing rules, wherein the rules at least (i) determine a next question based on a previous answer, (ii) determine that no further question needs to be selected and (iii) determine whether the next question is a duplicate of a previous question such that the previous question will only be presented once.

22. The method of claim 18, further comprising the steps of:
providing at least one quantitative question based on the response;
providing a financial analysis of the business solution based on at least one quantitative response to the at least one quantitative question.

23. A system for providing business solutions over an interactive communications medium, comprising:
means for providing selective business drivers associated with a specific industry;
means for selecting business metrics based on the selective business drivers; and
means for providing a business solution based on the selective business drivers and responses to the selected business metrics.

24. The system of claim 23, wherein the business solution is a general business solution.

25. The system of claim 24, further comprising means for providing a specific business solution based on the general business solution.

26. The system of claim 25, further comprising means for generating rules, the generating rules means providing (i) the selected metrics based on the responses, (ii) the general business solution based on the responses and the specific industry and (iii) the specific business solution based on the general business solution.

27. The system of claim 26, further comprising means for storing the metrics, the responses, the general business solution and the specific business solution.

28. The system of claim 25, further comprising means for providing a financial analysis of one of the general business solution and the specific business solution based on quantitative responses.

29. A system for providing business solutions over an interactive communications medium, comprising:
a business driver module which stores business measures associated with a specific industry;
a business metrics module which stores questions associated with the specific industry and at least one selected business measure stored in the business driver module; and
a business solution module which provides business solutions based on responses to selected questions stored in the business metrics module and the specific industry.

30. The system of claim 29, further comprising a quantitative metrics module associated with the business solution module, the quantitative metrics module storing specific quantitative questions.

31. The system of claim 30, further comprising a financial analysis module which calculates financial benefits of the business solution based on quantitative responses to selected specific quantitative questions stored in the quantitative metrics module.

32. The system of claim 30, further comprising a rules module which generates rules, the rules being used to determine the business solution based on the responses and pertinent questions to provide to a user based on the responses.

33. The system of claim 32, further comprising a database which stores the business driver module, the business metrics module, the responses and the business solution module.

34. The system of claim 30, wherein the business driver module, the business metrics module and the business solution module are accessed by one of a web page resident on a server, a telephone and a personal digital assistant.

35. A machine readable medium containing code for providing business solutions over an interactive communications medium, the code implementing the steps of:
selectively providing metrics which are associated with a business problem and a specific industry; and
providing a business solution based on the selective metrics and responses to the selective metrics.

36. The machine readable code of claim 35, further comprising the steps of:
selecting the specific industry; and
providing a business driver based on the selected specific industry,
wherein the selective metrics are associated with the selected specific industry and the business driver.

37. The machine readable code of claim 35, wherein the business solution is one of a general business solution and a specific business solution.

38. The machine readable code of claim 37, further comprising the step of ranking the business solution in order of business priority based on ranking rules.

39. The machine readable code of claim 37, wherein the business driver is a business specific measure defined as one of inventory, revenue, costs of goods sold, selling and administrative expenses, fixed assets, accounts receivable, and accounts payable.

40. The machine readable code of claim 35, further comprising the step of providing rules for determining a next metrics of the selective metrics based on a previous response to the selective metrics .

41. The machine readable code of claim 35, further comprising the step of providing quantitative metrics based on the selective metrics and the response.

42. The machine readable code of claim 35, further comprising the step of providing a financial analysis of the business solution based on at least one quantitative response to the quantitative metrics.
